(19) United States
(12) Patent Application Publication
(10) Pub. No.: US 2021/0312746 A1
(43) Pub. Date: Oct. 7, 2021

(54) BILL HANDLING DEVICE

(71) Applicant: Hitachi-Omron Terminal Solutions, Corp., Shinagawa-ku, Tokyo (JP)

(72) Inventors: Junji FUJITA, Tokyo (JP); Masato HARADA, Inazawa (JP); Kentaro MUTA, Tokyo (JP)

(73) Assignee: Hitachi-Omron Terminal Solutions, Corp., Shinagawa-ku, Tokyo (JP)

(21) Appl. No.: 17/263,203

(22) PCT Filed: May 10, 2019
(86) PCT No.: PCT/JP2019/018727

§ 371 Date: Jan. 26, 2021

(30) Foreign Application Priority Data
Aug. 9, 2018 (JP) 2018-150006

(51) Int. Cl. G07D 11/14; G07D 11/40

(52) U.S. Cl. CPC G07D 11/14; G07D 11/13; G07D 11/40

(57) ABSTRACT

Provided is a bill handling device including: a deposit opening into which bills are put; a withdrawal opening from which the bills are withdrawn; a shutter that is opened or closed to block or release an opening space of the withdrawal opening; and movable plates which are located on a lower side of the shutter in a closed state in which the shutter is closed, and are opened and closed with holding points set as fulcrums in an opened state in which the shutter is opened. The fulcrums as the holding points are located on a shutter side in the opened state in which the shutter is opened.

### TECHNICAL FIELD

The present invention relates to a bill handling device.

### BACKGROUND ART

There is known a bill handling device including a deposit opening into which bills are put, and a withdrawal opening that serves as a conveyance destination of withdrawal bills and a conveyance destination of rejected bills occurring in a deposit transaction. The bill handling device has a configuration in which a shutter is not mounted in the deposit opening, and bills can be stacked. In addition, a shutter, which is opened or closed by an actuator such as a motor to block or release the opening space that is a bill accumulation space of the withdrawal opening, is mounted in some withdrawal openings.

For example, in a bill handling device described in Patent Document 1, bills can be continuously put at the time of deposit. In addition, since a shutter of the withdrawal opening is opened, an operator can immediately reinsert rejected bills in the deposit transaction from the withdrawal opening to the deposit opening.

On a bill accumulation space side of the shutter in the withdrawal opening, a movable plate operating with a holding point set as a fulcrum is mounted in a site other than a central space into which a hand is inserted.

When the movable plate is closed by its own weight, an upper end of accumulated bills is stopped, and when the bills are withdrawn, the movable plate is pushed away by the bills withdrawn by an operator and is opened. Even when the shutter is opened at the time of deposit, the moveable plate prevents deposit rejected bills which are in a bad posture at the time of accumulation from popping out from the withdrawal opening.

### CITATION LIST

### Patent Document

Patent Document 1: JP 2016-99677 A

### SUMMARY OF THE INVENTION

### Problems to be Solved by the Invention

However, in Patent Document 1, with respect to a shutter that is opened or closed in front of an operator, the holding point that holds the movable plate is located on a side opposite to the opened shutter. According to this, in a case where it enters a state in which the movable plate is not closed due to operation failure or the like, when the shutter is closed, there is a possibility that the shutter pinches the movable plate. As a result, there is a concern that a failure in which the shutter is not completely closed may occur.

An object of the invention is to prevent a failure in which a shutter is not completely closed from occurring in a bill handling device.

### Solutions to Problems

According to an aspect of the invention, there is provided a bill handling device including: a deposit opening into which bills are put; a withdrawal opening from which the bills are withdrawn; a shutter that is opened or closed to block or release an opening space of the withdrawal opening;

and movable plates which are located on a lower side of the shutter in a closed state in which the shutter is closed, and are opened and closed with holding points set as fulcrums in an opened state in which the shutter is opened. The holding points are located on a shutter side in the opened state in which the shutter is opened.

According to another aspect of the invention, there is provided a bill handling device including: a deposit opening into which bills are put; a withdrawal opening from which the bills are withdrawn; a shutter that is opened or closed to block or release an opening space of the withdrawal opening; first movable plates which are located on a lower side of the shutter in a closed state in which the shutter is closed, and are opened and closed with first holding points set as fulcrums in an opened state in which the shutter is opened; and second movable plates which are provided on a lower side of the first movable plates, and are opened and closed with second holding points different from the first holding points set as fulcrums. The first holding points of the first movable plates are located on a shutter side in the opened state in which the shutter is opened, and the second holding points of the second movable plates are located on a side opposite to the shutter side.

### Effects of the Invention

According to the aspects of the invention, it is possible to prevent a failure in which a shutter is not completely closed from occurring in a bill handling device.

### BRIEF DESCRIPTION OF THE DRAWINGS

FIG. 1 is a perspective view illustrating a schematic external appearance of a bill handling device.

FIG. 2 is an explanatory view schematically illustrating a positional relationship between a counter clerk M and a customer K in a plan view of the bill handling device.

FIG. 3 is a control block diagram of the bill handling device.

FIG. 4 is a cross-sectional view schematically illustrating an internal configuration of the bill handling device and a bill conveyance route.

FIG. 5 is a perspective view illustrating a configuration of a shutter and a movable plate in Example 1.

FIG. 6 is a side view illustrating the configuration of the shutter and the movable plate in Example 1.

FIG. 7 is an explanatory view schematically describing a route configuration that participates in deposit conveyance among configurations of bill conveyance routes.

FIG. 8 is a control flow chart of deposit transaction.

FIG. 9 is an explanatory view schematically describing a route configuration that participates in withdrawal conveyance.

FIG. 10 is a control flow chart of withdrawal transaction.

FIG. 11 is a side view illustrating a configuration of a shutter and a movable plate in Example 2.

FIG. 12 is a side view illustrating the configuration of the shutter and the movable plate in Example 2.

FIG. 13 is a side view illustrating a configuration of a movable plate in Example 3.

### MODE FOR CARRYING OUT THE INVENTION

### Example 1

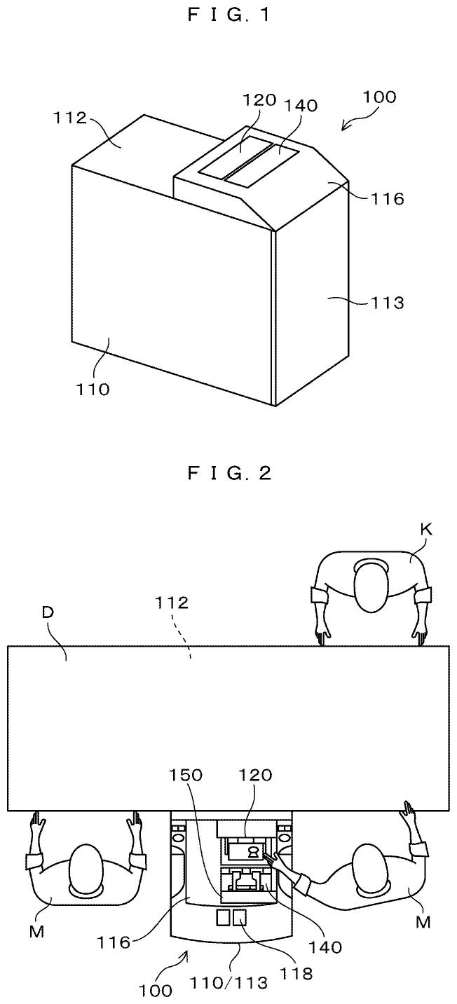

A configuration of a bill handling device 100 will be described with reference to FIG. 1.

As illustrated in FIG. 1, the bill handling device 100 is divided into upper and lower parts in an external appearance, a lower region is referred to as a safe 110, and an upper region above a housing part 112 of the safe 110 is referred to as a deposit and withdrawal mechanism part 116. The housing part 112 is formed from a metal steel plate, is provided with a metal safe door 113 that can be opened and closed and can be locked on a front side of the paper surface in FIG. 1, and constitutes the safe 110 in combination with the safe door 113.

The bill handling device 100 accommodates a bill identification unit 170, a bill storage part 200, and the like to be described later in the housing part 112 that can be closed by the safe door 113, thereby securing security. An operator can deposit bills from a deposit opening 120 or can withdraw bills from a withdrawal opening 140.

Next, another installation aspect of the bill handling device 100 will be described with reference to FIG. 2. FIG. 2 is an explanatory view schematically illustrating a positional relationship between a counter clerk M and a customer K in a plan view of the bill handling device 100.

The deposit and withdrawal mechanism part 116 includes an operation panel 118 that is operated by the counter clerk. An upper surface is provided the withdrawal opening 140 and the deposit opening 120 adjacent to each other in this order from a front side to a depth side of the paper surface in FIG. 1, that is, from a front surface side to a rear surface side of the device.

The bill handling device 100 has a configuration in which a rear side of the device is covered with a customer response table D, and the deposit opening 120 and the withdrawal opening 140 of the deposit and withdrawal mechanism part 116 are visible to a customer K. The counter clerk M faces the customer K with the customer response table D interposed therebetween, and puts bills B deposited by the customer K into the deposit opening 120, or delivers bills withdrawn to the withdrawal opening 140 to the customer K in addition to a predetermined operation on the operation panel 118.

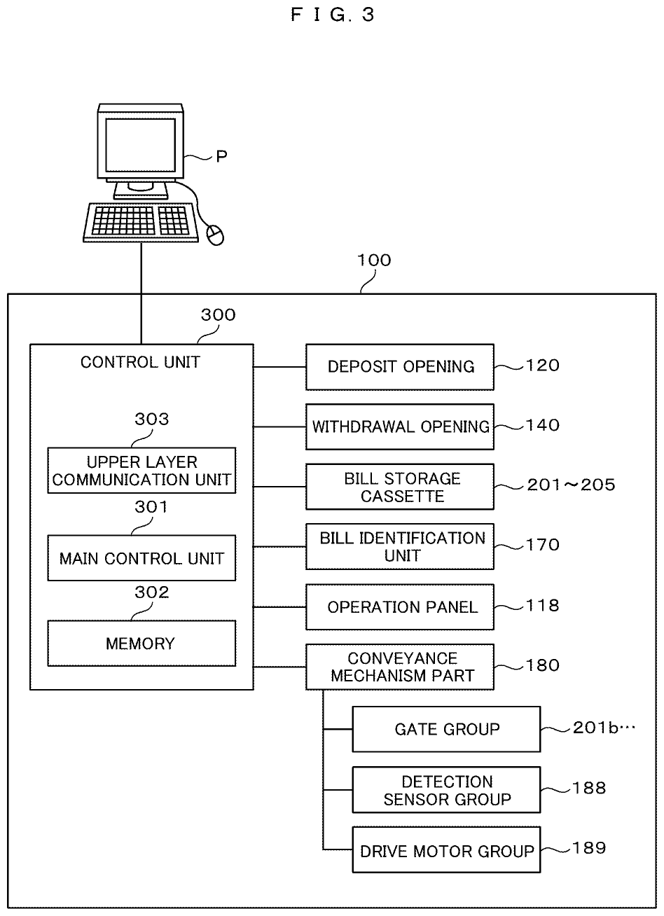

Next, an electrical configuration of a control block of the bill handling device 100 will be described with reference to FIG. 3.

As illustrated in FIG. 3, the bill handling device 100 includes the deposit opening 120, the withdrawal opening 140, bill storage cassettes 201 to 205, a bill identification unit 170, the operation panel 118, a conveyance mechanism part 180, and a control unit 300 as electrical functional blocks. As to be described later, the conveyance mechanism part 180 includes a gate group including gates starting from a gate 201b for each cassette, a detection sensor group of a plurality of detection sensors 188 provided in a bill conveyance route, and a drive motor group of a plurality of drive motors 189 responsible for bill conveyance.

The control unit 300 includes a main control unit 301, a memory 302, and an upper layer communication unit 303 capable of communicating with an operation terminal P. The main control unit 301 is constituted by a microprocessor mainly for control. The main control unit 301 drives and controls drive devices and the like which are included in the deposit opening 120 or the withdrawal opening 140 and participate in bill transmission and conveyance, and the gate group and the drive motor group of the conveyance mechanism part 180 in accordance with bill deposit and withdrawal conveyance. The detection sensors 188 included in the detection sensor group detect a bill conveyance state in a bill deposit route 1801N and a bill withdrawal route 180OUT to be described later, whether or not bills exist in the deposit opening 120 or the withdrawal opening 140, the number of sheets of bills stored in the bill storage cassettes 201 to 205, and the like, and outputs detection signals to the control unit 300.

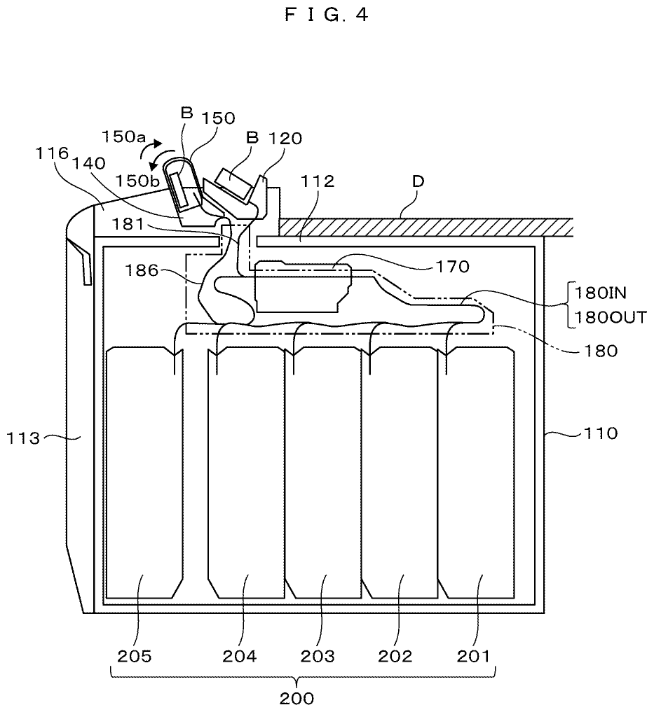

Next, an internal configuration of the bill handling device 100 will be described with reference to FIG. 4.

As illustrated in FIG. 4, in the deposit and withdrawal mechanism part 116, the deposit opening 120 for receiving the deposit of the bills B and the withdrawal opening 140 for withdrawing the bills B are disposed to be adjacent to each other. The housing part 112 of the safe 110 accommodates and includes the bill identification unit 170, the conveyance mechanism part 180, and the bill storage part 200. An identification result obtained by the bill identification unit 170 is output to the control unit 300 (refer to FIG. 3), and is used in determination of a cassette as a bill conveyance destination, reject conveyance, and the like.

The conveyance mechanism part 180 corresponding to a conveyance unit forms the bill deposit route 180IN and the bill withdrawal route 180OUT over a range from the deposit opening 120 and the withdrawal opening 140 to the bill storage part 200. Details of the both routes will be described later, and the bill deposit route 180IN includes an upstream side deposit route 181 ranging from the deposit opening 120 to the bill identification unit 170. The bill withdrawal route 180OUT includes a downstream side withdrawal route 186 ranging from the bill identification unit 170 to the withdrawal opening 140. The conveyance mechanism part 180 including the routes conveys bills by connecting the deposit opening 120 and the withdrawal opening 140 to the bill identification unit 170 and the bill storage part 200 in the deposit and withdrawal route. The bill storage part 200 includes the bill storage cassettes 201 to 205, and stores the bills B in each of the cassettes as to be described later.

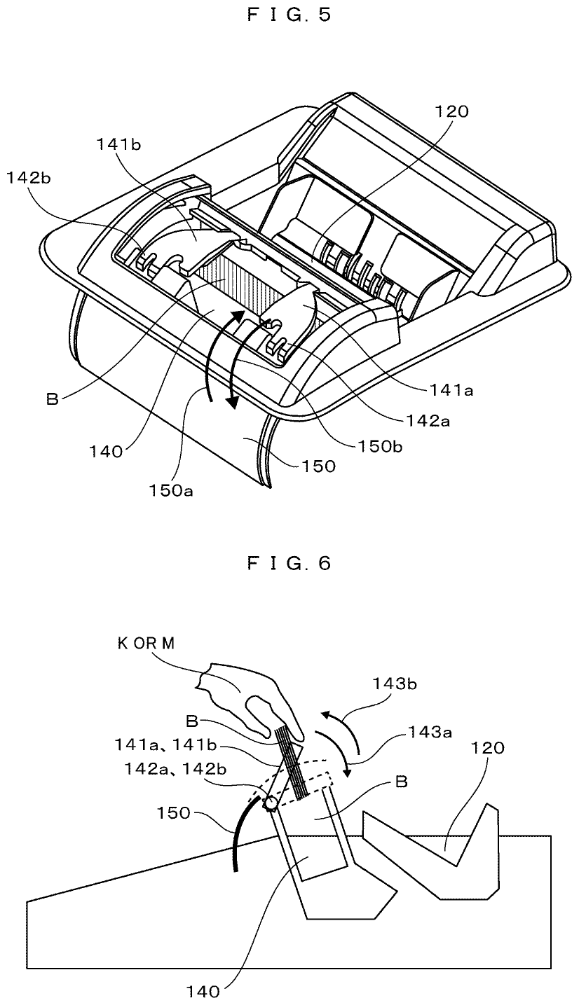

Next, details of the deposit and withdrawal openings of Example 1 will be described later with reference to FIG. 5 and FIG. 6. Here, FIG. 5 is a perspective view in which a shutter 150 is in an opened state, and FIG. 6 is a side view when an operator withdraws bills.

As illustrated in FIG. 5, the withdrawal opening 140 includes the shutter 150. In a closed state, the shutter 150 slides in a direction indicated by an arrow 150a, that is, to the deposit opening 120 side, and covers the entirety of an upward side of the withdrawal opening 140 to limit operations such as withdrawal and putting of the bills B, and insertion of a hand. In an opened state, the shutter 150 slides in a direction indicated by an arrow 150b, that is, to a downward side, and enables an operation for the withdrawal opening 140 to be performed. Movable plates 141a and 141b are mounted in a bill accumulation space side of the shutter 150.

The movable plates 141a and 141b are held by fulcrums 142a and 142b to be the shutter side when the shutter 150 enters an opened state (with regard to symbols a and b, when viewed from the front side of the bill handling device 100, the right side is indicated by a and the left side is indicated by b, and although not illustrated in the drawing, a configuration and an operation are the same in each case. Note that, the fulcrums are divided into the right side and the left side in the drawing, but may be penetrated). In addition, a spring member (not illustrated) that presses the movable plates 141a and 141b in a closing direction is formed at the fulcrums 142a and 142b. Typically, the movable plates 141a and 141b are in a closed state by a spring force.

In addition, the movable plates 141a and 141b independently open or close in directions indicated by arrows 143a and 143b with the fulcrums 142a and 142b set as fulcrums. Alternatively, in the case of being integrally formed, the movable plates 141a and 141b integrally open or close. In addition, when the movable plates 141a and 141b are closed, accumulated bills are received. When an operator withdraws the bills B, as illustrated in FIG. 6, the movable plates 141a and 141b enter an opened state.

As illustrated in FIG. 5 and FIG. 6, the bill handling device of Example 1 includes the deposit opening 120 into which the bills B are put, the withdrawal opening 140 from which the bills B are withdrawn, the shutter 150 that is opened or closed to block (limit) or release the opening space of the withdrawal opening 140, and the movable plates 141a and 141b which are located on a lower side of the shutter 150 in a closed state in which the shutter 150 is closed, and are opened and closed with holding points set as the fulcrums 142a and 142b in an opened state in which the shutter 150 is opened. The fulcrums 142a and 142b which are holding points are located on the shutter side in the opened state in which the shutter 150 is opened.

In addition, rejected bills which occur in deposit transaction are conveyed to the withdrawal opening 140. One end of each of the movable plates 141a and 141b is held by the fulcrum 142a or 142b that is a holding point, the other end is not held and is opened or closed to an operator side with the holding point set as the fulcrum.

In addition, in a closed state, the shutter 150 slides to the deposit opening side, and blocks the opening space of the withdrawal opening 140. On the other hand, in an opened state, the shutter 150 slides to a side opposite to the deposit opening side, and releases the opening space of the withdrawal opening 140. The movable plates 141a and 141b receive the bills B conveyed to the withdrawal opening 140 in a closed state, and enters an opened state until the bills B conveyed to the 140 withdrawal opening are withdrawn.

According to Example 1, since the shutter 150 and the movable plates 141a and 141b are provided, even in a state in which the shutter 150 is opened, alignment of the bills B accumulated can be stabilized. That is, withdrawal properties of the bills B can be improved.

In addition, according to Example 1, it is possible to prevent the movable plates 141a and 141b from being pinched by the shutter 150, and causing operation failure of the shutter 150 to occur. That is, it is possible to prevent occurrence of close failure of the shutter 150 due to collision with the movable plates 141a and 141b when being opened or closed.

As described above, according to the bill handling device of Example 1, even though the movable plates 141a and 141b are not closed, the shutter 150 can be closed while closing the movable plates 141a and 141b. According to this, operation failure of the shutter 150 can be prevented, and a bill handling device with high reliability can be provided.

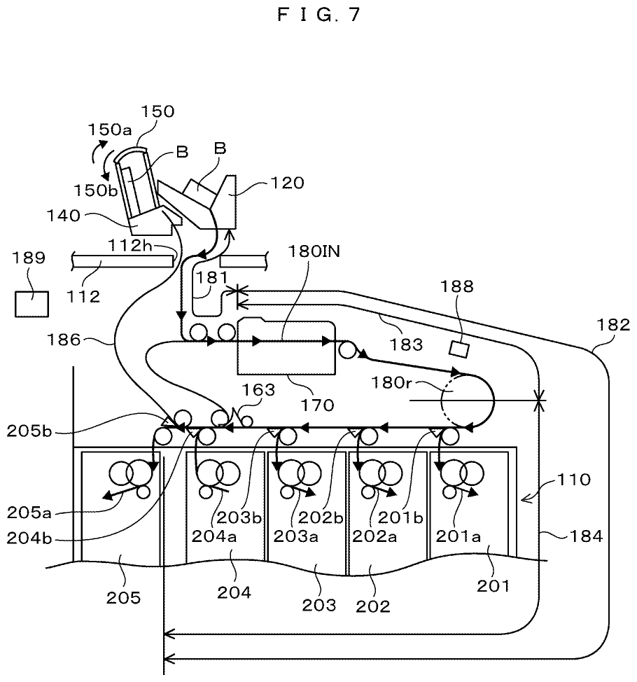

Next, a deposit conveyance process will be described with reference to FIG. 7.

As illustrated in FIG. 7, the bill deposit route 180IN extends from the deposit opening 120, and reaches the bill identification unit 170 through the housing part 112. Then, the bill deposit route 180IN is folded back by a direction switching roller 180r located downstream the bill identification unit 170 in a route, and extends to the bill storage cassette 205 along respective cassettes of the bill storage part 200 located on a downward side of the bill identification unit 170. In the bill deposit route 180IN having the route trajectory, a route ranging from the deposit opening 120 to the bill identification unit 170 is set as an upstream side deposit route 181, and a route downstream the above-described route is set as a downstream side deposit route 182.

The conveyance mechanism part 180 forms the downstream side deposit route 182 by a first main conveyance route 183 that extends to the direction switching roller 180r after passing through the bill identification unit 170, and a second main conveyance route 184 that is folded back by the direction switching roller 180r, extends in a horizontal direction, and reaches the bill storage cassette 205 of the bill storage part 200. The bills B put into the deposit opening 120 are separated sheet by sheet and are sent out to the conveyance route. The conveyance mechanism part 180 performs deposit conveyance of the bills B which are sent out to the conveyance route along the route of the bill deposit route 1801N, and performs deposit conveyance to any one of the bill storage cassettes 201 to 205 in accordance with an identification result obtained by the bill identification unit 170.

Bills determined as rejected bills by the bill identification unit 170 pass through the downstream side withdrawal route 186 through a gate 205b and are conveyed to the withdrawal opening 140. At this time, since the shutter 150 is in an opened state at the time of deposit, an operator inserts a hand between the movable plates 141a and 141b and withdraws the bills B which are rejected bills accumulated in the withdrawal opening 140 with a force equal to greater than a spring force pressing downward the movable plates 141a and 141b. Then, the operator sets again the bills B in the deposit opening 120 for redeposit as necessary.

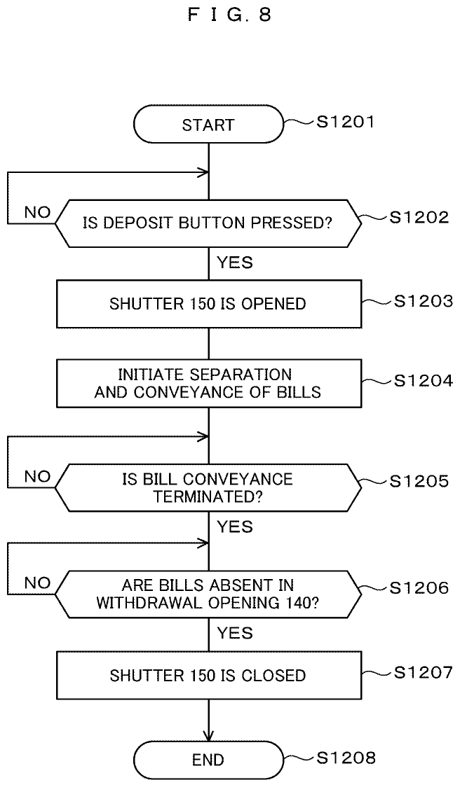

Next, a shutter operation in a deposit transaction will be described with reference to FIG. 8.

When the bill handling device 100 enters a stand-by state (S1201), pressing of a deposit button is monitored (S1202). When the deposit button is pressed, the shutter 150 is opened (S1203), and separation and conveyance of bills put into the deposit opening 120 are initiated (S1204). During conveyance of the bills, the shutter 150 is held in an opened state.

After the bill conveyance is terminated (S1205), it is determined whether or not bills exist in the withdrawal opening 140 (S1206), and the bill handling device 100 waits until all of the rejected bills conveyed to the withdrawal opening 140 are withdrawn. When the bills disappear from the withdrawal opening 140, the shutter 150 is closed (S1207). Then, the transaction is terminated (S1208).

Here, bill separation initiation timing and timing of opening the shutter 150 are determined by monitoring pressing of the deposit button. However, the deposit button may not be provided, bill separation may be set to be initiated at time when the control unit 300 in FIG. 3 receives a deposit command, and the shutter 150 may be opened before the initiation.

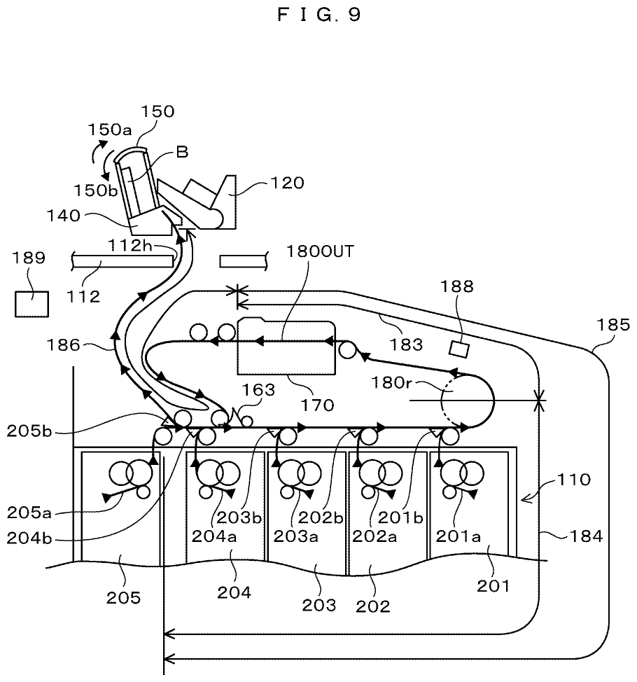

Next, a withdrawal conveyance process will be described with reference to FIG. 9.

The control unit 300 that receives a withdrawal command from the operation terminal P in FIG. 3 through the upper layer communication unit 303 controls the drive motor group 189, and moves bills B from the bill storage cassettes 201 to 205 to the withdrawal opening 140. At this time, the bills B are moved from the bill storage cassettes 201 to 205 by the number of sheets designated from the operation terminal P. As an example, description will be given of a conveyance route in a case where a withdrawal bill reject storage is assigned to the bill storage cassette 204.

Bills sent out from the bill storage cassettes 201, 202, and 203 pass through the bill withdrawal route 180OUT, and the bill identification unit 170 determines whether the bills are normal bills or rejected bills. Bills determined as normal bills pass through the downstream side withdrawal route 186 through a gate 163, and are conveyed to the withdrawal opening 140. Bills determined as rejected bills are conveyed to the withdrawal bill reject storage of the cassette 204 through a gate 204b. Then, the shutter 150 is opened and the bills are withdrawn by putting a hand into the center of the movable plates 141a and 141b.

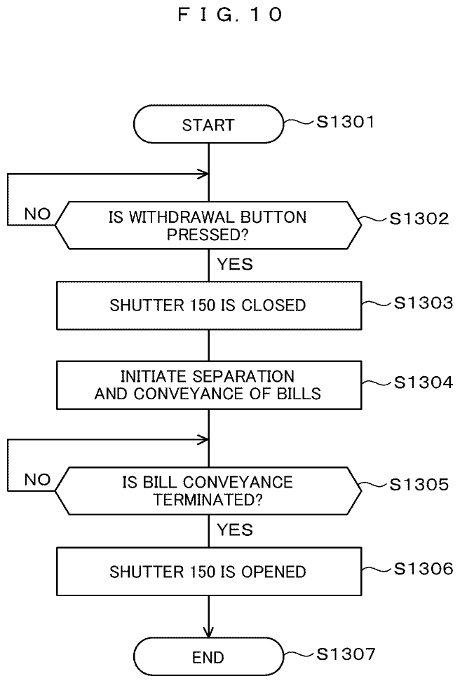

Next, a shutter operation in a withdrawal transaction will be described with reference to FIG. 10.

When the bill handling device 100 enters a standby state (S1301), pressing of a withdrawal button is monitored (S1302). When the withdrawal button is pressed, the shutter 150 is closed (S1303), and separation and conveyance of bills from the bill storage part 200 are initiated (S1304). During conveyance of the bills, the shutter 150 is held to a closed state. After the bill conveyance is terminated (S1305), the shutter 150 is opened (S1306), and it enters a state in which the bills can be withdrawn from the withdrawal opening 140.

Then, the transaction is terminated (S1307).

### Example 2

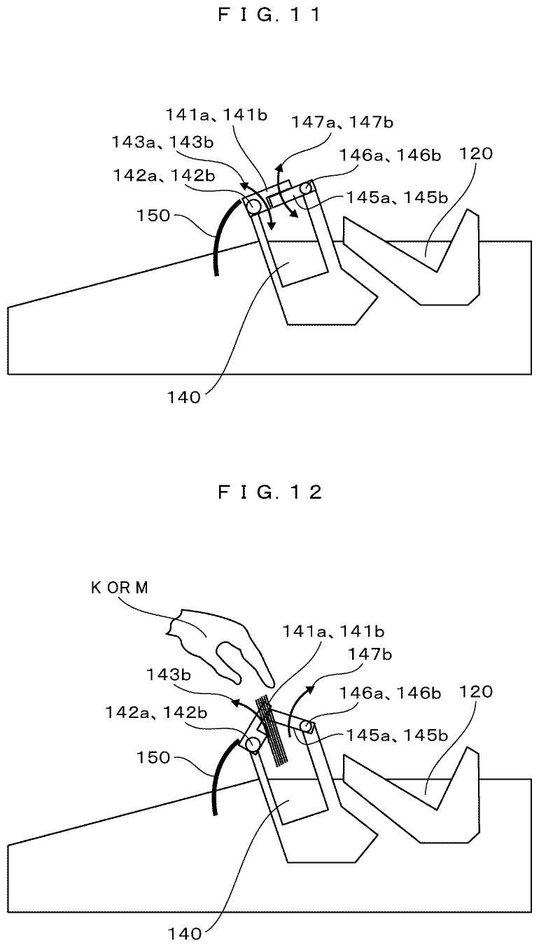

Next, a configuration of deposit and withdrawal openings of Example 2 will be described with reference to FIG. 11 and FIG. 12.

Here, FIG. 11 is a side view of a state in which the shutter 150 is opened, and FIG. 12 is a side view when an operator withdraws bills.

As illustrated in FIG. 11, second movable plates 145a and 145b are mounted on a side opposite to the first movable plates 141a and 141b. The second movable plates 145a and 145b are held by fulcrums 146a and 146b, respectively (a relationship of symbols a and b is as described above. Note that, as described above, the fulcrums 146a and 146b may be penetrated), and are opened and closed in a direction indicated by arrows 147a and 147b. In addition, a spring member (not illustrated) that presses the second movable plates 145a and 145b in a closing direction is formed at the fulcrums 146a and 146b. Typically, the movable plates 145a and 145b are in a closed state. In addition, in the closed state, the second movable plates 145a and 145b are located on a lower side of the first movable plates 141a and 141b.

In addition, the second movable plates 145a and 145b are independently opened and closed with holding points set as the fulcrums 146a and 146b in the direction indicated by the arrows 147a and 147b. Alternatively, in a case where the second movable plates 145a and 145b are integrally formed, the second movable plates 145a and 145b are integrally opened and closed. The first movable plates 141a and 141b partially cover the withdrawal opening 140, and the second movable plates 145a and 145b cover the remaining part. According to this, the length of the first movable plates 141a and 141b in Example 2 is shorter than the length of the movable plates 141a and 141b illustrated in FIG. 6 in Example 1.

In addition, as illustrated in FIG. 12, even in a case where the first movable plates 141a and 141b and the second movable plates 145a and 145b are in the most opened state, the second movable plates 145a and 145b are configured to be located on a lower side of the first movable plates 141a and 141b. The other configuration and an operation of the bill handling device are the same as in Example 1, and thus description thereof will be omitted.

As illustrated in FIG. 11 and FIG. 12, the bill handling device of Example 2 includes the deposit opening 140 into which the bills B are put, the withdrawal opening 120 from which the bills B are withdrawn, the shutter 150 that is opened or closed to block or release the opening space of the withdrawal opening 120, the first movable plates 141a and 141b which are located on a lower side of the shutter 150 in a closed state in which the shutter 150 is closed, and are opened and closed with first holding points set as the fulcrums 142a and 142b in an opened state in which the shutter 150 is opened, and the second movable plates 145a and 145b which are provided on a lower side of the first movable plates 141a and 141b, and are opened and closed with the second holding points different from the first holding points set as fulcrums 146a and 146b.

The first holding points (fulcrums 142a and 142b) of the first movable plates 141a and 141b are located on a shutter side in an opened state in which the shutter 150 is opened, and the second holding points (fulcrums 146a and 146b) of the second movable plates 145a and 145b are located on a side opposite to the shutter side.

In addition, the first movable plates 141a and 141b cover a part of the opening space, and the second movable plates 145a and 145b cover the other part of the opening space. In addition, the first movable plates 141a and 141b and the second movable plates 141a and 141b cover all parts of the opening space in a closed state.

In addition, one end of each of the second movable plates 145a and 145b is held by the second holding point (fulcrum 146a or 146b), and the other end of each of the second movable plates 145a and 145b is not held and is located on a lower side of the first movable plates 141a or 141b in the opened state and the closed state.

In Example 1, as illustrated in FIG. 6, the length of the movable plates set to cover the entirety of the opening space becomes long. According to this, when an operator withdraws the bills B from the withdrawal opening 140, the movable plates become an obstacle, and operability is poor. Here, in Example 2, as illustrated in FIG. 11 and FIG. 12, the opening space is partially covered with the first movable plates 141a and 141b, and the remainder of the opening space is covered with the second movable plates 145a and 145b different from the first movable plates 141a and 141b.

In Example 2, since the length of the movable plates can be shortened, the operability when the operator withdraws the bills B becomes satisfactory. In addition, since the movable plates (second movable plates 145a and 145b) on an opposite side also operate, the movable plate does not hinder withdrawal of the bills B, and the bills B can be easily withdrawn.

### Example 3

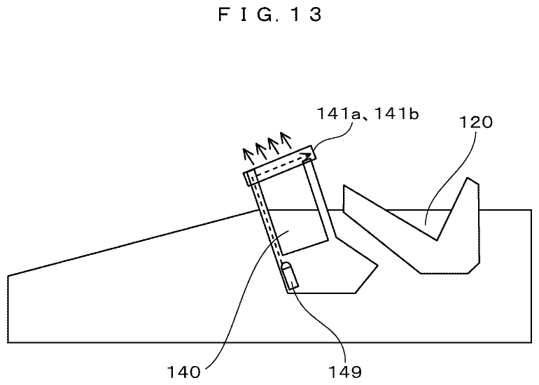

Next, a configuration of deposit and withdrawal openings of Example 3 will be described with reference to FIG. 13.

As illustrated in FIG. 13, in Example 3, the first movable plates 141a and 141b is transparent, and a light source 149 is mounted in the vicinity of the withdrawal opening 140. In a case where rejected bills or withdrawal bills exist in the withdrawal opening 140, the light source 149 is caused to emit light by a power supply control unit (not illustrated) so as to notify an operator of the existence. The light source 149 may be lighted or blinked or may be lighted and blinked. The other configurations and operations of the bill handling device are the same as in Example 1, and thus description thereof will be omitted.

As illustrated in FIG. 13, in the bill handling device of Example 3, the movable plates 141a and 141b are formed in a transparent plate. In addition, the light source 149 is provided at a predetermined position in the withdrawal opening 140, and emits light to the transparent movable plates 141a and 141b.

According to Example 3, since the movable plates 141a and 141b are formed in a transparent plate, at bill accumulation timing, the movable plates 141a and 141b are lighted or blinked by the near light source 149. According to this, an operator notices existence of the bills B, and does not forget bill withdrawal. As a result, the subsequent clerk processing becomes unnecessary, and device downtime can be minimized.

### REFERENCE SIGNS LIST

100 Bill handling device
110 Safe
112 Housing part
113 Safe door
116 Deposit and withdrawal mechanism part
118 Operation panel
120 Deposit opening
140 Withdrawal opening
141a, 141b First movable plate
145a, 145b Second movable plate
149 Light source
150 Shutter
170 Bill identification unit
180 Conveyance mechanism part
188 Detection sensor
189 Drive motor
200 Bill storage part
201 to 205 Bill storage cassette
300 Control unit
301 Main control unit
302 Memory
303 Upper layer communication unit
B Bills
M Counter clerk
K Customer
D Customer response table
P Operation terminal

1. A bill handling device comprising:
a deposit opening into which bills are put;
a withdrawal opening from which the bills are withdrawn;
a shutter that is opened or closed to block or release an opening space of the withdrawal opening; and
movable plates which are located on a lower side of the shutter in a closed state in which the shutter is closed, and are opened and closed with holding points set as fulcrums in an opened state in which the shutter is opened,
wherein the holding points are located on a shutter side in the opened state in which the shutter is opened.

2. The bill handling device according to claim 1,
wherein rejected bills occurring in a deposit transaction are conveyed to the withdrawal opening.

3. The bill handling device according to claim 1,
wherein one end of each of the movable plates is held by each of the holding points, and the other end is not held and is opened or closed with the holding point set as a fulcrum.

4. The bill handling device according to claim 1,
wherein the shutter blocks the opening space of the withdrawal opening in the closed state, and
the shutter releases the opening space of the withdrawal opening in the opened state.

5. The bill handling device according to claim 1, further comprising:
a spring member that is provided at the holding points of the movable plates and presses the movable plates in a closing direction.

6. The bill handling device according to claim 1,
wherein the movable plates receive the bills conveyed to the withdrawal opening in a closed state, and enter an opened state when the bills conveyed to the withdrawal opening is withdrawn.

7. The bill handling device according to claim 1,
wherein the movable plates are formed in a transparent plate, and
a light source, which is provided at a predetermined position in the withdrawal opening and emits light to the transparent movable plates, is further provided.

8. A bill handling device comprising:
a deposit opening into which bills are put;
a withdrawal opening from which the bills are withdrawn;
a shutter that is opened or closed to block or release an opening space of the withdrawal opening;
first movable plates which are located on a lower side of the shutter in a closed state in which the shutter is closed, and are opened and closed with first holding points set as fulcrums in an opened state in which the shutter is opened; and
second movable plates which are provided on a lower side of the first movable plates, and are opened and closed with second holding points different from the first holding points set as fulcrums,
wherein the first holding points of the first movable plates are located on a shutter side in the opened state in which the shutter is opened, and
the second holding points of the second movable plates are located on a side opposite to the shutter side.

9. The bill handling device according to claim 8,
wherein the first movable plates cover a part of the opening space,
the second movable plates cover the other part of the opening space, and
the first movable plates and the second movable plates cover the entirety of the opening space in the closed state.

10. The bill handling device according to claim 8,
wherein one end of each of the second movable plates is held by each of the second holding points and the other end is not held, and
the other end of the second movable plate is located on a lower side of the first movable plates in the opened state and the closed state.
